(19) United States
(12) Patent Application Publication
(10) Pub. No.: US 2008/0218027 A1
(43) Pub. Date: Sep. 11, 2008

(54) Circuit and Method for Controlling a Piezoelectric or Electrostrictive Actuator

(76) Inventors: Bernhard Gottlieb, Munchen (DE); Andreas Kappel, Brunnthal (DE); Juan Manuel Roldan Gomez, Armilla (Granada) (ES); Tim Schwebel, Munchen (DE); Carsten Wallenhauer, Schwarzheide (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/065,332

(22) PCT Filed: Sep. 5, 2006
(86) PCT No.: PCT/EP2006/065987

§ 371 Date: Mar. 27, 2008

(30) Foreign Application Priority Data
Sep. 5, 2005 (DE) 10 2005 042 107.5

(51) Int. Cl. H02N 2/06

(52) U.S. Cl. 310/316.03

(57) ABSTRACT

A circuit and/or a corresponding method for controlling a piezoelectric or electrostrictive actuator (P) have a series-connected driver stage (G) which provides a control signal which is used to drive the piezoelectric actuator (P). A reference capacitor (M), which is used to measure a charge (qP) of the actuator (P), is serially connected to the actuator (P). The reference capacitor (M) is used as a series capacitor in order to measure the actuator charge (q<SUB>A</SUB>(T)=q<SUB>P</SUB>(t)) of the piezoelectric actuator. The output variable is a voltage which is proportional to the actuator charge. The voltage is guided to an A/D-converter and is processed further in a digital manner or guided directly to a analogue controller.

### CROSS-REFERENCE TO RELATED APPLICATIONS

This application is a U.S. national stage application of International Application No. PCT/EP2006/065987 Filed Sep. 5, 2006, which designates the United States of America, and claims priority to German application number 10 2005 042 107.5 filed Sep. 5, 2005, the contents of which are hereby incorporated by reference in their entirety.

### TECHNICAL FIELD

The invention relates to a circuit for controlling a piezoelectric or electrostrictive actuator, and to a method for controlling a piezoelectric or electrostrictive actuator with such a circuit.

### BACKGROUND

Piezoelectric actuators are used in many different ways as final control elements. The use of these actuators requires an electronic circuit specially adapted to the application, which can control the actuator with a high level of accuracy and efficiency. Depending on requirements, such a control electronics assembly can exhibit a very high level of complexity and significantly increase the costs of the entire drive system.

In a drive system based on such an actuator the precise, controlled or regulated change in the actuator length is the basis of the function. The change in length is determined by parameters such as actuator charge, previous history of the actuator charge and actuator temperature. With regard to controlling the actuator, a knowledge of the charging time function is therefore of vital importance. For the purpose of precise control of the actuator, a control loop based on the charge of the actuator is generally used. A function block for measuring the charge of the piezoelectric actuator thus constitutes an important part of the mechatronic system.

Previously the measurement of charge at piezoelectric actuators has taken place by way of the intermediate step of measuring the actuator current and subsequently performing integration. To this end a shunt resistance is connected in series with the actuator against zero potential. The actuator current is converted by way of the resistance into a proportional voltage drop. The voltage is integrated in a second step. In this situation, the integration is performed in either analog or digital fashion by way of an upstream A/D converter, an FPGA or a microcontroller.

The circuitry and software requirements and thus the costs for the function block for carrying out charge measurement are comparatively high in the case of said known variant. The A/D conversion in particular must take place at a high sampling rate depending on the control signal. The digital integration requires additional resources in a microcontroller or an FPGA. Any adaptation to reduced accuracy requirements depending on the application is possible only to a limited extent when using this procedure.

### SUMMARY

A circuit for controlling a piezoelectric or electrostrictive actuator in respect of its structure and a method for controlling a piezoelectric or electrostrictive actuator with such a circuit can be simplified, whereby in particular a reduction in costs and if applicable an adaptation to reduced requirements should be enabled. According to an embodiment, a circuit for controlling a piezoelectric or electrostrictive actuator may comprise an upstream driver stage serving to provide a control signal for driving the actuator, and a reference capacitor connected in series downstream of the actuator for measuring a charge of the actuator.

According to a further embodiment, the driver stage and the reference capacitor may be connected to a common reference potential. According to a further embodiment, a voltage drop across the reference capacitor can be derived as an output signal proportional to the charge of the actuator. According to a further embodiment, according to

$${u}_{A} ( t ) = \frac{1}{{C}_{M}} \cdot {q}_{M} ( t )$$

the output signal u_{A}(t) is proportional to a quotient of a reference capacitor capacitance value C_{M} of the reference capacitor is the charge of the reference capacitor. According to a further embodiment, the circuit may comprise, after an elapsed time T, a charge of q(T) according to

$$q ( T ) = {q}_{p} ( T ) = {q}_{M} ( T ) = {\int }_{t = 0}^{T} i ( t ) d t + Q ( t = 0 )$$

where i(t) is the current flowing through the actuator and through the reference capacitor. According to a further embodiment, a charge of the actuator q_{P}(t) may be equal or proportional to a charge q_{M}(t) of the reference capacitor. According to a further embodiment, the circuit may be operable to perform approximately currentless measurement of a voltage across the reference capacitor. According to a further embodiment, the circuit may comprise a reset circuit which is connected in order to discharge the reference capacitor. According to a further embodiment, the reset circuit can be implemented by means of a resistor connected in parallel with the reference capacitor or by means of a switch connected in parallel with the reference capacitor. According to a further embodiment, the circuit may comprise a directly connected A/D converter or a directly connected analog controller. According to a further embodiment, the circuit may comprise a calibration circuit for reducing an error which is caused by drift of component parameters, whereby the calibration circuit is designed and connected to determine a transmission factor at intervals in time in the form of a charge relating to a voltage drop at the reference capacitor. According to a further embodiment, the circuit may comprise a control or regulation facility for controlling or regulating the driver stage on the basis of a value for the measured charge of the actuator. According to a further embodiment, a frequency band in the range 10 mHz<f<1 kHz may be used.

According to another embodiment, a method for controlling a piezoelectric or electrostrictive actuator may comprise the steps of: providing by an upstream driver stage a control signal for driving the actuator, and measuring a charge of the actuator by a reference capacitor connected in series downstream of the actuator.

According to a further embodiment, a voltage drop across the reference capacitor can be derived as an output signal proportional to the charge of the actuator. According to a further embodiment, a voltage can be measured across the reference capacitor in approximately currentless fashion. According to a further embodiment, the reference capacitor may be reset by a resistor connected in parallel with the reference capacitor or by a switch which is connected in parallel with the reference capacitor and which is closed and opened again at intervals in time. According to a further embodiment, in order to reduce an error, which is caused by drift of component parameters, a transmission factor can be determined by a calibration method at intervals in time in the form of a charge relating to a voltage drop at the reference capacitor. According to a further embodiment, the measured charge of the actuator may be used for controlling or regulating the driver stage. According to a further embodiment, a frequency band in the range 10 mHz<f<1 kHz may be used.

### BRIEF DESCRIPTION OF THE DRAWINGS

An embodiment will be described in detail in the following with reference to the drawing. In the drawings:

FIG. 1 shows an exemplary circuit for controlling a piezoelectric actuator,

FIG. 2 shows a circuit modified compared with FIG. 1,

FIG. 3 shows a further circuit modified compared with FIG. 1 and

FIG. 4 shows a phase response and a transmission function of such a circuit.

### DETAILED DESCRIPTION

By preference, a circuit may be accordingly provided for controlling a piezoelectric or electrostrictive actuator with an upstream driver stage serving to provide a control signal for driving the actuator, whereby a reference capacitor which is used for measuring a charge of the actuator is connected in series downstream of the actuator.

Particularly advantageous may be a circuit in which the driver stage and the reference capacitor are connected to a common reference potential.

Particularly advantageous may be a circuit in which a voltage drop across the reference capacitor can be derived as an output signal proportional to the charge of the actuator. Particularly advantageous is a circuit in which according to

$${u}_{A} ( t ) = \frac{1}{{C}_{M}} \cdot {q}_{M} ( t )$$

the output signal u_{A}(t) is proportional to a quotient of a reference capacitor capacitance value C_{M} of the reference capacitor where q_{M}(t) is the charge of the reference capacitor.

Particularly advantageous may be a circuit with, after an elapsed time T, a charge q(T) according to

$$q ( T ) = {q}_{p} ( T ) = {q}_{M} ( T ) = {\int }_{t = 0}^{T} i ( t ) d t + Q ( t = 0 )$$

where i(t) is the current flowing through the actuator and through the reference capacitor. Particularly advantageous is a circuit in which a charge of the actuator q_{P}(t) is equal or proportional to a charge q_{M}(t) of the reference capacitor.

Particularly advantageous may be a circuit which is designed to perform approximately currentless measurement of a voltage across the reference capacitor.

Particularly advantageous may be a circuit with a reset circuit which is connected in order to discharge the reference capacitor, whereby the reset circuit is preferably implemented by means of a resistor connected in parallel with the reference capacitor or by means of a switch connected in parallel with the reference capacitor.

Particularly advantageous may be a circuit with a directly connected A/D converter or a directly connected analog controller.

Particularly advantageous may be a circuit with a calibration circuit for reducing an error which is caused by drift of component parameters, whereby the calibration circuit is designed and connected such that a transmission factor is determined at intervals in time in the form of a charge relating to a voltage drop at the reference capacitor.

Advantageous may be a circuit with a control or regulation facility for controlling or regulating the driver stage on the basis of a value for the measured charge of the actuator.

According to a further embodiment, a method may be preferred for controlling particularly such a circuit with a piezoelectric or electrostrictive actuator and with a driver stage connected upstream of the latter in order to provide a control signal for driving the actuator, whereby a reference capacitor for measuring a charge of the actuator is connected in series downstream of the actuator.

Particularly advantageous may be a method in which a voltage drop across the reference capacitor is derived as an output signal proportional to the charge of the actuator. Particularly advantageous is a method in which a voltage across the reference capacitor is measured in approximately currentless fashion. Particularly advantageous may be a method in which the reference capacitor is reset by a resistor connected in parallel with the reference capacitor or by a switch which is connected in parallel with the reference capacitor and which is closed and opened again at intervals in time. Particularly advantageous may be a method in which in order to reduce an error, which is caused by drift of component parameters, a transmission factor is determined by a calibration method at intervals in time in the form of a charge relating to a voltage drop at the reference capacitor

Particularly advantageous may be a method in which the measured charge of the actuator is used for controlling or regulating the driver stage.

Advantageous can be such a circuit or such a method in which a frequency band in the range 10 mHz<f<1 kHz is used.

A series capacitor can be accordingly utilized as a reference capacitor in order to measure an actuator charge of a piezoelectric actuator. The output variable is a voltage proportional to the actuator charge. Depending on the application, this voltage is fed to an A/D converter and further processed digitally or fed directly to an analog controller.

Such a preferred circuit for controlling a piezoelectric actuator and such a method for controlling a piezoelectric actuator using such a circuit also may have disadvantages compared with known embodiments. The long-term stability of the component parameters and the temperature drift of the reference capacitor are thus inferior compared with a shunt resistance. An error or a drift in the capacitance value have a direct influence on the accuracy of measurement. As in the case of a measurement using a shunt resistance, it is also possible in the case of measurement using a reference capacitor to significantly reduce an error, which is caused by drift of component parameters, by means of a suitable calibration circuit. The calibration circuit determines the transmission factor at extended intervals in time, particularly as a transmission factor in the form of a charge relating to a voltage drop.

The advantages, however, outweigh these disadvantages. An extremely simple structure can be advantageous. Furthermore, a scalability of accuracy with scalable costs can be advantageous, whereby the choice of the reference capacitor is defines the cost. The fact that no digital integration is required can also be advantageous as this results in a reduced resource requirement.

It is also advantageously possible to directly connect an A/D converter (A/D: analog/digital), particularly without an amplifier, because the signal to be measured already has a high energy level.

Also advantageous can be a continuous measurement which makes possible a reduction in the speed requirement on the A/D converter in a digital system, which applies particularly when using clocked piezo drivers.

Also advantageous can be low demands on the reference capacitor with regard to parasitic elements. Parasitic elements of the reference capacitor have very little disadvantageous effect on the accuracy of measurement in a limited frequency band.

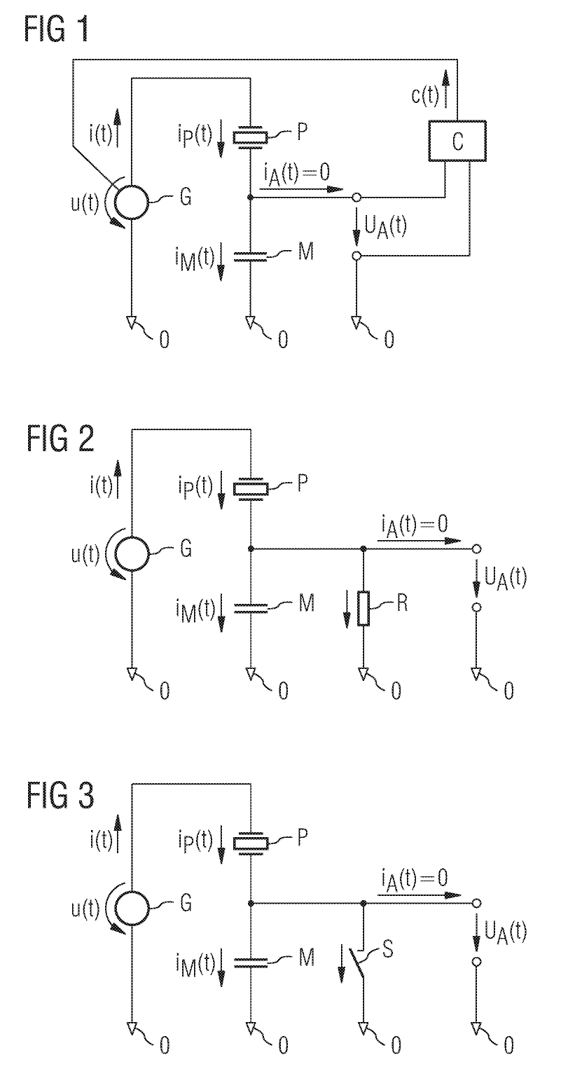

As can be seen from FIG. 1, an essential aspect of a basic circuit consists in the use of a reference capacitor M connected in series with a piezoelectric actuator P for measuring a charge q_{P} of the piezoelectric actuator P.

The reference capacitor M is connected in series with the piezoelectric actuator P against zero potential 0.

The same current i(t) from a driver stage G taking the form for example of a generator flows through the actuator P and through the reference capacitor M. As a result, the same charge q(t)=q_{P}(t) or q(t)=q_{M}(t) respectively is stored in both elements. Accordingly, the following applies generally or to the specific reference capacitor with a reference capacitance value C_{M}

$$u ( t ) = \frac{1}{C} \cdot q ( t ) \\ or \\ {u}_{A} ( t ) = \frac{1}{{C}_{M}} \cdot {q}_{M} ( t ) \qquad ( 1 )$$

where u(t) is a voltage from the driver stage G and C is the total capacitance value for the total capacitance. In this situation, a voltage drop across the reference capacitor M is proportional to the stored charge q_{M} of the reference capacitor M. The capacitance value C_{M} of the reference capacitor M represents the proportionality factor.

The driver stage G provides a suitable control signal, a voltage-time function or a current-time function, for driving the piezoelectric actuator P. The driver stage G is connected directly to the actuator P. The second terminal of the actuator P is connected in series to the reference capacitor M. The zero potential 0 of the circuit represents the reference potential of the reference capacitor M. If a voltage measurement is performed across the reference capacitor M in approximately currentless fashion, the following applies

$$q ( T ) = {q}_{p} ( T ) = {q}_{M} ( T ) = {\int }_{t = 0}^{T} i ( t ) d t + Q ( t = 0 ) \\ where \\ i ( t ) = {i}_{p} ( t ) = {i}_{M} ( t ) . \qquad ( 2 )$$

Accordingly, the same charge q(t) is stored in both capacitive elements, in other words in the actuator P and in the reference capacitor M. The stored charge q(t) causes a proportional voltage drop across the reference capacitor M. The voltage drop across the reference capacitor M represents the output signal u_{A}(t) proportional to the charge q_{P} of the actuator P.

The determination of the charge q_{P} of the actuator P takes place for example in a control facility C to which the output signal u_{A}(t) is applied. The control facility C preferably also determines a control or regulation signal c(t) which is applied to the driver stage G in order to control or regulate the driver stage G.

Further exemplary embodiments are illustrated in FIG. 2 and in FIG. 3. The reference capacitor M is discharged by a reset circuit, whereby the charge q(t=0) stored in the reference capacitor M is set to zero. Resetting can for example take place according to FIG. 2 using a resistor R or according to FIG. 3 using a switch S. Resetting by way of the resistor R is particularly simple and suitable for periodic operation of the actuator P. In this situation, the circuit consisting of the actuator P, the reference capacitor M and the resistor R constitutes a high-pass filter. In this manner, the stability of an integrator formed in such a way, for example compared with bias currents which would result in a drift in the case of an integration, is improved.

Parasitic elements of the reference capacitor M develop its apparent internal resistance. As an RC element (RC: resistor-capacitor) with the capacitance C_{M} of the actuator P, the parasitic resistor connected in series with the reference capacitor M, restricts the usage to high frequencies. The parallel parasitic resistor of the reference capacitor M and the reference capacitor M form an RC element which through its high-pass response restricts the usage at low frequencies. With regard to realistic component parameters for typical applications, a frequency band of at least 10 mHz<f<1 kHz is usable in particular. The use of special low-loss and thus expensive capacitors, tantalum capacitors for example, is no longer advantageously imperative depending on the application.

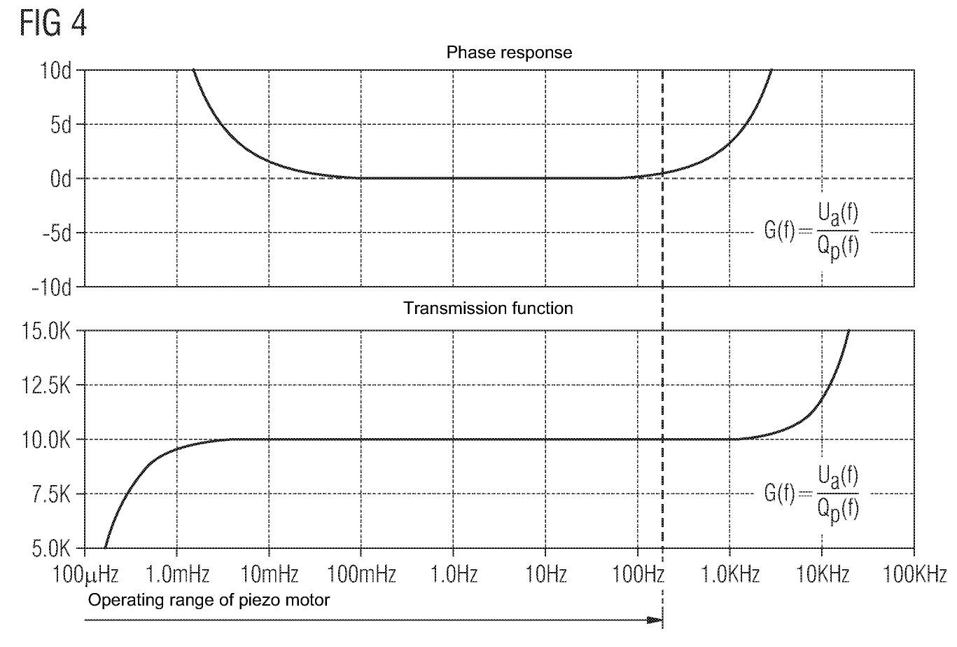

The effect of the parasitic elements of the reference capacitor M can be simulated on the basis of exemplary parameters with a reference capacitor capacitance value C_{M}=100 μF and an actuator capacitance value C_{P}=1 μF. The parasitic resistor in series with the reference capacitor M here is 100 mOhm, an equivalent series inductance of the reference capacitor M here is 30 nH and the parasitic resistor in parallel with the reference capacitor M here is RpM=6 MOhm. This data corresponds to that of an average electrolytic capacitor. The result of the simulation is illustrated in FIG. 4. The transmission function of the output voltage u_{A}(t) with reference to the actuator charge q_{P}(t) is shown plotted against the frequency f. In this situation, a phase response is shown in the upper illustration and an amplification in the lower illustration. It is evident that the parasitic elements surprisingly have no negative influence on the accuracy of measurement over a wide frequency range.

As confirmed experimentally, an accuracy comparable with known methods is thus achieved with a significantly reduced circuitry complexity.

It is advantageously possible for example to implement a direct, in particular amplifier-free, connection of an A/D converter (A/D: analog/digital), to which the output signal u_{A}(t) is applied. In practice, with an exemplary reference capacitor capacitance value C_{M}=470 μF and an output voltage −2V<UA<2V, it is evident that the signal to be measured already has a high energy level

$$E = C \cdot U \frac{2}{A} .$$

What is claimed is:

1. A circuit for controlling a piezoelectric or electrostrictive actuator comprising:
an upstream driver stage serving to provide a control signal for driving the actuator, and
a reference capacitor connected in series downstream of the actuator for measuring a charge of the actuator.

2. The circuit according to claim 1, wherein the driver stage and the reference capacitor are connected to a common reference potential.

3. The circuit according to claim 1, wherein a voltage drop across the reference capacitor can be derived as an output signal proportional to the charge of the actuator.

4. The circuit according to claim 3, wherein according to
$${u}_{A} ( t ) = \frac{1}{{C}_{M}} \cdot {q}_{M} ( t )$$
the output signal u_{A}(t) is proportional to a quotient of a reference capacitor capacitance value C_{M} of the reference capacitor is the charge of the reference capacitor.

5. The circuit according to claim 1, comprising, after an elapsed time T, a charge of q(T) according to
$$q ( T ) = {q}_{p} ( T ) = {q}_{M} ( T ) = {\int }_{t = 0}^{T} i ( t ) d t + Q ( t = 0 )$$
where i(t) is the current flowing through the actuator and through the reference capacitor.

6. The circuit according to claim 4, wherein a charge of the actuator q_{P}(t) is equal or proportional to a charge q_{M}(t) of the reference capacitor.

7. The circuit according to claim 1, wherein the circuit is operable to perform approximately currentless measurement of a voltage across the reference capacitor.

8. The circuit according to claim 1, comprising a reset circuit which is connected in order to discharge the reference capacitor.

9. The circuit according to claim 8, wherein the reset circuit is implemented by means of a resistor connected in parallel with the reference capacitor or by means of a switch connected in parallel with the reference capacitor.

10. The circuit according to claim 1, comprising a directly connected A/D converter or a directly connected analog controller.

11. The circuit according to claim 1, comprising a calibration circuit for reducing an error which is caused by drift of component parameters, whereby the calibration circuit is designed and connected to determine a transmission factor at intervals in time in the form of a charge relating to a voltage drop at the reference capacitor.

12. The circuit according to claim 1, comprising a control or regulation facility for controlling or regulating the driver stage on the basis of a value for the measured charge of the actuator.

13. A method for controlling a piezoelectric or electrostrictive actuator comprising the steps of:
providing by an upstream driver stage a control signal for driving the actuator, and
measuring a charge of the actuator by a reference capacitor connected in series downstream of the actuator.

14. The method according to claim 13, wherein a voltage drop across the reference capacitor is derived as an output signal proportional to the charge of the actuator.

15. The method according to claim 13, wherein a voltage is measured across the reference capacitor in approximately currentless fashion.

16. The method according to claim 13, wherein the reference capacitor is reset by a resistor connected in parallel with the reference capacitor or by a switch which is connected in parallel with the reference capacitor and which is closed and opened again at intervals in time.

17. The method according to claim 13, wherein in order to reduce an error, which is caused by drift of component parameters, a transmission factor is determined by a calibration method at intervals in time in the form of a charge relating to a voltage drop at the reference capacitor.

18. The method according to claim 13, wherein the measured charge of the actuator is used for controlling or regulating the driver stage.

19. The method according to claim 13, wherein a frequency band in the range 10 mHz<f<1 kHz is used.

20. The circuit according to claim 1, wherein a frequency band in the range 10 mHz<f<1 kHz is used.
